(19) United States
(12) Patent Application Publication
(10) Pub. No.: US 2026/0141586 A1
(43) Pub. Date: May 21, 2026

(54) VISUALIZATION EDGE COMPUTE WITH VIRTUAL DISPLAY

(71) Applicant: Rockwell Automation Technologies, Inc., Mayfield Heights, OH (US)

(72) Inventors: Luca Begnini, Verona (IT); Luca Bennati, Verona (IT); Fabio Rolandone, Giussano (IT); Andrea Ognissanti, Giussano (IT)

(21) Appl. No.: 19/350,422

(22) Filed: Oct. 6, 2025

Related U.S. Application Data
(60) Provisional application No. 63/721,097, filed on Nov. 15, 2024.

(51) Int. Cl. G06T 11/20; G06F 3/0484; G06F 9/455

(52) U.S. Cl. CPC G06T 11/26; G06F 3/0484; G06F 9/45558; G06F 2009/45595; G06T 2200/24

(57) ABSTRACT

An industrial edge visualization device installs on the edge level of an industrial enterprise, collects data from industrial assets of automation systems, and transmits this data to the cloud, allowing users to monitor and analyze machine or system data from any location. The device can execute a visualization platform as a containerized application, using the platform to generate and publish animated dashboards that are accessible from any location via a web browser.

### CROSS-REFERENCE TO RELATED APPLICATIONS

This application claims priority to U.S. Provisional Patent Application Ser. No. 63/721,097, filed on Nov. 15, 2024, and entitled “VISUALIZATION EDGE COMPUTE WITH VIRTUAL DISPLAY,” the entirety of which is incorporated herein by reference.

### TECHNICAL FIELD

The subject matter disclosed herein relates generally to industrial automation systems, and, for example, to remote visualization of industrial operational, status, and analytic data

### BACKGROUND ART

Industrial human-machine interfaces, or HMIs, typically comprise a computer terminal with display capabilities that executes an HMI runtime application, which defines the graphical display screens used to visualize operational and status information for an corresponding industrial automation system, the navigation structure for navigating between the display screens, and the data links or bindings between graphical elements of the display screens and corresponding data tags of an industrial controller or other control and monitoring devices associated with the automation system. Due to architectural limitations, these HMIs are typically installed locally near their corresponding automation systems so that data to be visualized on the HMI can be read from necessary control devices.

### BRIEF DESCRIPTION

The following presents a simplified summary in order to provide a basic understanding of some aspects described herein. This summary is not an extensive overview nor is intended to identify key/critical elements or to delineate the scope of the various aspects described herein. Its sole purpose is to present some concepts in a simplified form as a prelude to the more detailed description that is presented later.

In one or more embodiments, a device is provided, comprising a device interface component configured to read device data from industrial assets of an automation system via a machine network of an industrial enterprise; a visualization component configured to generate a dashboard in accordance with a visualization application stored on the device; and a publishing component configured to publish the dashboard and the device data to a cloud-based virtual machine as an animated dashboard accessible via a web browser.

Also, one or more embodiments provide a method, comprising reading, by an edge-level visualization device, device data from industrial assets of an automation system via a machine network of an industrial enterprise; generating, by the edge-level visualization device, a dashboard in accordance with a visualization application stored on the edge-level visualization device; and publishing, by the edge-level visualization device, the dashboard and the device data to a cloud-based virtual machine as an animated dashboard accessible via a web browser.

Also, according to one or more embodiments, a non-transitory computer-readable medium is provided having stored thereon instructions that, in response to execution, cause an edge-level visualization device comprising a processor to perform operations, the operations comprising reading device data from industrial assets of an automation system via a machine network of an industrial enterprise; generating a dashboard in accordance with a visualization application stored on the edge-level visualization device; and publishing the dashboard and the device data to a cloud-based virtual machine as an animated dashboard accessible via a web browser

To the accomplishment of the foregoing and related ends, certain illustrative aspects are described herein in connection with the following description and the annexed drawings. These aspects are indicative of various ways which can be practiced, all of which are intended to be covered herein. Other advantages and novel features may become apparent from the following detailed description when considered in conjunction with the drawings.

### BRIEF DESCRIPTION OF THE DRAWINGS

FIG. 1 is a block diagram of an example industrial control environment.

FIG. 2 is a block diagram of an example edge visualization device.

FIG. 3 is a diagram illustrating an example ecosystem in which the edge visualization device can be used.

FIG. 4 is a diagram illustrating generation and delivery of local dashboards to a client device using the edge visualization device.

FIG. 5 is an example local dashboard that can be generated and delivered by the edge visualization device.

FIG. 6 is a diagram illustrating generation and delivery of remote dashboards to a client device using the edge visualization device.

FIG. 7 is an example remote dashboard that can be generated and delivered by the edge visualization device.

FIG. 8 is a diagram illustrating an architecture in which the edge visualization device acts as an edge-level gateway for remote access to the industrial assets.

FIG. 9a is a General view of a device configuration interface.

FIG. 9b is a Data Sources view of the device configuration interface.

FIG. 9c is a Data Destinations Configuration view of the device configuration interface.

FIG. 9d is a Dashboard view of the device configuration interface.

FIG. 10a is a flowchart of a first part of an example methodology for serving local and remote industrial dashboards from an edge-level visualization device.

FIG. 10b is a flowchart of a second part of the example methodology for serving local and remote industrial dashboards from an edge-level visualization device.

FIG. 11 is an example computing environment.

FIG. 12 is an example networking environment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding thereof. It may be evident, however, that the subject disclosure can be practiced without these specific details. In other instances, well-known structures and devices are shown in block diagram form in order to facilitate a description thereof.

As used in this application, the terms “component,” “system,” “platform,” “layer,” “controller,” “terminal,” “station,” “node,” “interface” are intended to refer to a computer-related entity or an entity related to, or that is part of, an operational apparatus with one or more specific functionalities, wherein such entities can be either hardware, a combination of hardware and software, software, or software in execution. For example, a component can be, but is not limited to being, a process running on a processor, a processor, a hard disk drive, multiple storage drives (of optical or magnetic storage medium) including affixed (e.g., screwed or bolted) or removable affixed solid-state storage drives; an object; an executable; a thread of execution; a computer-executable program, and/or a computer. By way of illustration, both an application running on a server and the server can be a component. One or more components can reside within a process and/or thread of execution, and a component can be localized on one computer and/or distributed between two or more computers. Also, components as described herein can execute from various computer readable storage media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that provides at least in part the functionality of the electronic components. As further yet another example, interface(s) can include input/output (I/O) components as well as associated processor, application, or Application Programming Interface (API) components. While the foregoing examples are directed to aspects of a component, the exemplified aspects or features also apply to a system, platform, interface, layer, controller, terminal, and the like.

As used herein, the terms “to infer” and “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In addition, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Furthermore, the term “set” as employed herein excludes the empty set; e.g., the set with no elements therein. Thus, a “set” in the subject disclosure includes one or more elements or entities. As an illustration, a set of controllers includes one or more controllers; a set of data resources includes one or more data resources; etc. Likewise, the term “group” as utilized herein refers to a collection of one or more entities; e.g., a group of nodes refers to one or more nodes.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches also can be used.

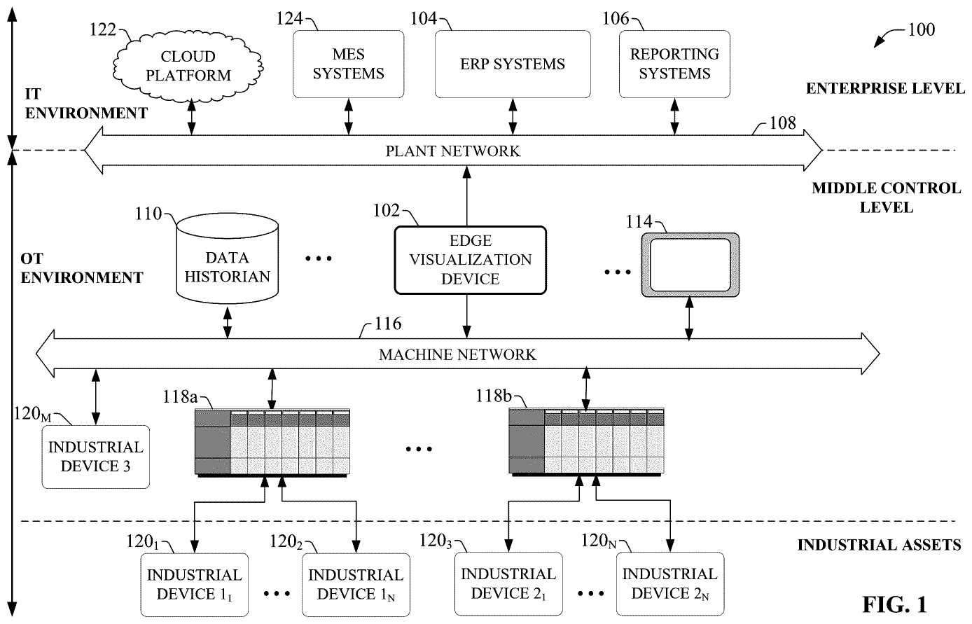

FIG. 1 is a block diagram of an example industrial environment 100. In this example, a number of industrial controllers 118 are deployed throughout an industrial plant environment to monitor and control respective industrial systems or processes relating to product manufacture, machining, motion control, batch processing, material handling, or other such industrial functions. Industrial controllers 118 typically execute respective control programs to facilitate monitoring and control of industrial devices 120 making up the controlled industrial assets or systems (e.g., industrial machines). One or more industrial controllers 118 may also comprise a soft controller executed on a personal computer, on a server blade, or other hardware platform, or on a cloud platform. Some hybrid devices may also combine controller functionality with other functions, such as visualization. The control programs executed by industrial controllers 118 can comprise any conceivable type of code used to process input signals read from the industrial devices 120 and to control output signals generated by the industrial controllers, including but not limited to ladder logic, sequential function charts, function block diagrams, structured text, C++, Python, Javascript, etc.

Industrial devices 120 may include input devices (e.g., sensors, meters, telemetry devices, etc.) that provide data relating to the controlled industrial systems to the industrial controllers 118, output devices (e.g., effectors, actuators, motor contactors, indicator lights, etc.) that respond to control signals generated by the industrial controllers 118 to control aspects of the industrial systems, or devices that act as both input and output devices. Industrial devices 120 can comprise digital input devices (e.g., push buttons, selector switches, safety devices, proximity switches, photo sensors, etc.), digital output devices (e.g., solenoid values, indicator lights, motor contactors, etc.), analog input devices (e.g., 4-20 mA telemetry devices, 0-10 VDC telemetry devices, or other analog measurement devices), or analog output devices (e.g., variable frequency drives, flow control valves, speed control devices, etc.).

While some industrial controllers 118 communicatively interface with industrial devices 120 over hardwired connections, many industrial controllers 118 exchange data with some or all of the industrial devices 120 over a network using a suitable industrial communication protocol such as CIP Class 1 or Profinet.

Industrial automation systems often include one or more human-machine interfaces (HMIs) 114 that allow plant personnel to view telemetry and status data associated with the automation systems, and to control some aspects of system operation. HMIs 114 may communicate with one or more of the industrial controllers 118 over a machine network 116, and exchange data with the industrial controllers to facilitate visualization of information relating to the controlled industrial processes on one or more pre-developed operator interface screens. HMIs 114 can also be configured to allow operators to submit data to specified data tags or memory addresses of the industrial controllers 118, thereby providing a means for operators to issue commands to the controlled systems (e.g., cycle start commands, device actuation commands, etc.), to modify setpoint values, etc. HMIs 114 can generate one or more display screens or interfaces through which the operator interacts with the industrial controllers 118, and thereby with the controlled processes and systems. Example display screens can visualize present states of industrial systems or their associated devices using graphical representations of the processes that display metered or calculated values, employ color or position animations based on state, render alarm notifications, or employ other such techniques for presenting relevant data to the operator. Data presented in this manner is read from industrial controllers 118 by HMIs 114 and presented on one or more of the display screens according to display formats chosen by the HMI developer.

Some industrial environments may also include other systems or devices relating to specific aspects of the controlled industrial systems. These may include, for example, one or more data historians 110 that aggregate and store production information collected from the industrial controllers 118 and other industrial devices.

Industrial devices 120, industrial controllers 118, HMIs 114, associated controlled industrial assets, and other plant-floor systems such as data historians 110, vision systems, and other such systems operate on the operational technology (OT) level of the industrial environment. Higher level analytic and reporting systems may operate at the higher enterprise level of the industrial environment in the information technology (IT) domain; e.g., on a plant network 108 or on a cloud platform 122. Such higher level systems can include, for example, enterprise resource planning (ERP) systems 104 that integrate and collectively manage high-level business operations, such as finance, sales, order management, marketing, human resources, or other such business functions. Manufacturing Execution Systems (MES) 124 can monitor and manage control operations on the control level given higher-level business considerations. Reporting systems 106 can collect operational data from industrial devices on the plant floor and generate daily or shift reports that summarize operational statistics of the controlled industrial assets.

The real-time operational, status, and production information for an industrial automation system or process is typically only viewable locally via the HMIs 114 associated with those systems. While the advent of the industrial internet of things (IIoT) has broadened the scope of access to industrial data, the complexity of configuring remote access to plant floor data remains a barrier to wide-spread adoption.

To address these and other issues, one or more embodiments described herein provide an edge visualization device 102 that can be installed at the edge level of an industrial enterprise—that is, at the machine's edge—and can collect, process, analyze and transmit data from industrial automation systems on the OT level to a cloud platform, allowing users to monitor and analyze machine or system data from substantially any location. The edge visualization device 102 can store and execute visualization applications defining graphical interfaces or dashboards that can be delivered to users at remote locations and populated with live or historical industrial data collected from the industrial controllers 118 and devices 120 that make up the automation systems. The edge visualization device 102 can also serve as an edge-level gateway for remote access to the controllers 118, industrial devices 120, and machines that make up the automation systems. The edge visualization device 102 is a headless stand-alone device with networking capabilities that allow the device 120 to be connected to both the machine (OT) network 116 and the plant (IT) network 108.

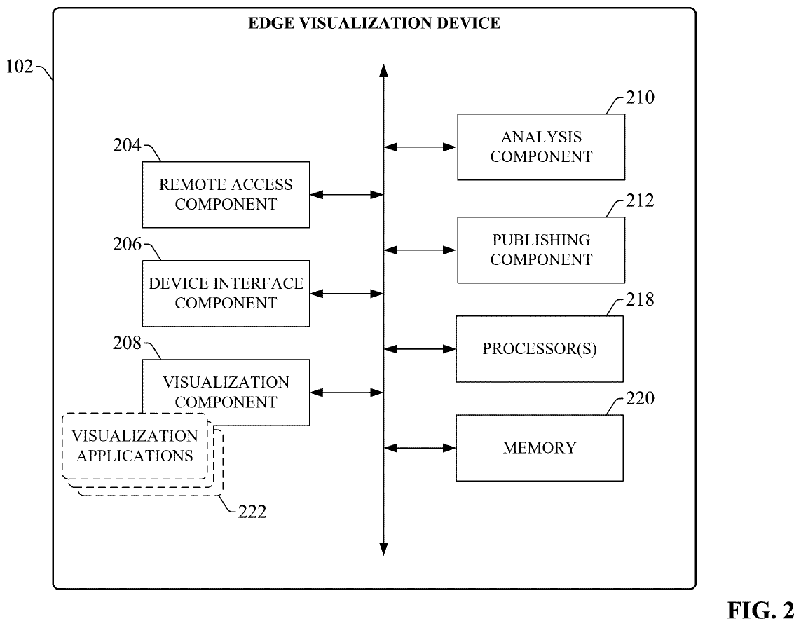

FIG. 2 is a block diagram of an example edge visualization device 102 according to one or more embodiments of this disclosure. Aspects of the systems, apparatuses, or processes explained in this disclosure can constitute machine-executable components embodied within machine(s), e.g., embodied in one or more computer-readable mediums (or media) associated with one or more machines. Such components, when executed by one or more machines, e.g., computer(s), computing device(s), automation device(s), virtual machine(s), etc., can cause the machine(s) to perform the operations described.

Edge visualization device 102 can include a remote access component 204, a device interface component 206, a visualization component 208, an analysis component 210, a publishing component 212, one or more processors 218, and memory 220. In various embodiments, one or more of the remote access component 204, device interface component 206, visualization component 208, analysis component 210, publishing component 212, the one or more processors 218, and memory 220 can be electrically and/or communicatively coupled to one another to perform one or more of the functions of the edge visualization device 102. In some embodiments, components 204, 206, 208, 210, and 212 can comprise software instructions stored on memory 220 and executed by processor(s) 218. Edge visualization device 102 may also interact with other hardware and/or software components not depicted in FIG. 2. For example, processor(s) 218 may interact with one or more external user interface devices, such as a keyboard, a mouse, a display monitor, a touchscreen, or other such interface devices.

Remote access component 204 can be configured to establish and manage a remote data connection between industrial assets on the machine network 116 on which the device 102 resides and remote client devices. Device interface component 206 can be configured to retrieve data generated by industrial devices associated with an industrial automation system (e.g., industrial controllers 118 or other industrial devices) during operation of the automation system. Device interface component 206 can retrieve this data from various data sources, including the industrial devices themselves, controller emulators, repositories of archived historical data, or other such sources.

Visualization component 208 can be configured to execute visualization applications 222 that define graphical interfaces or dashboards for rendering operational and status data obtained by the device interface component 206, as well as analytical data generated by the analysis component 210. The analysis component 210 can be configured to perform various types of analysis on real-time or historical data collected from the industrial assets or devices that make up the automation system. Publishing component 212 can be configured to publish selected data—including industrial asset data collected by the device interface component 206 and analytic data generated by the analysis component 212—to virtual machines or remote access managers that execute on a cloud platform.

The one or more processors 218 can perform one or more of the functions described herein with reference to the systems and/or methods disclosed. Memory 220 can be a computer-readable storage medium storing computer-executable instructions and/or information for performing the functions described herein with reference to the systems and/or methods disclosed.

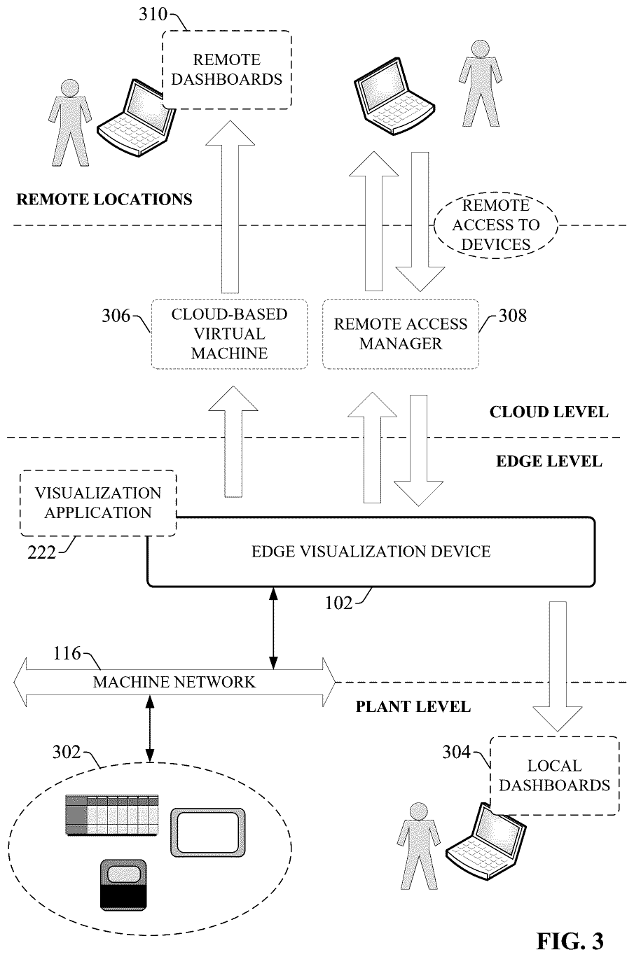

FIG. 3 is a diagram illustrating an example ecosystem in which the edge visualization device 102 can be used. As noted above, the edge visualization device 102 is a headless stand-alone device that can be installed at an industrial facility at the edge level, serving as an edge gateway between industrial assets 302 on the plant floor (e.g., industrial controllers 118 and devices 120 that make up automation systems that operate within the plant facility) and a cloud platform. The device 102 comprises data ports (e.g., RJ45 ports or other types of ports) that allow the device to be connected to both the machine network 116 on which the industrial assets 302 operate and the plant network 108 (not shown in FIG. 3) through which the device 102 can connect to a cloud platform. The device 102 can support any suitable networking protocol, including but not limited to network address translation (NAT), 1:1 NAT, routing, internet sharing, or other such protocols. In some embodiments, the housing of the device 102 can include integrated installation features, such as DIN rail mounting features, that allow the device 102 to be easily installed in an industrial cabinet or other industrial environments.

Edge visualization device 102 can execute visualization applications 222 that define graphical dashboards for presenting information about the operations of automation systems on the plant floor. The device 102 can deliver both local dashboards 304 to client devices having access to the device 102 via local connection to the plant network 108, as well as remote dashboards 310 to client devices at remote locations. The edge visualization device 102 can send remote dashboards 310 via cloud-based virtual machines 306 on the cloud platform. In addition, the edge visualization device 102 can interface with a remote access manager 308 on the cloud platform, and thus serve as an edge-level gateway for remote access to the industrial assets 302.

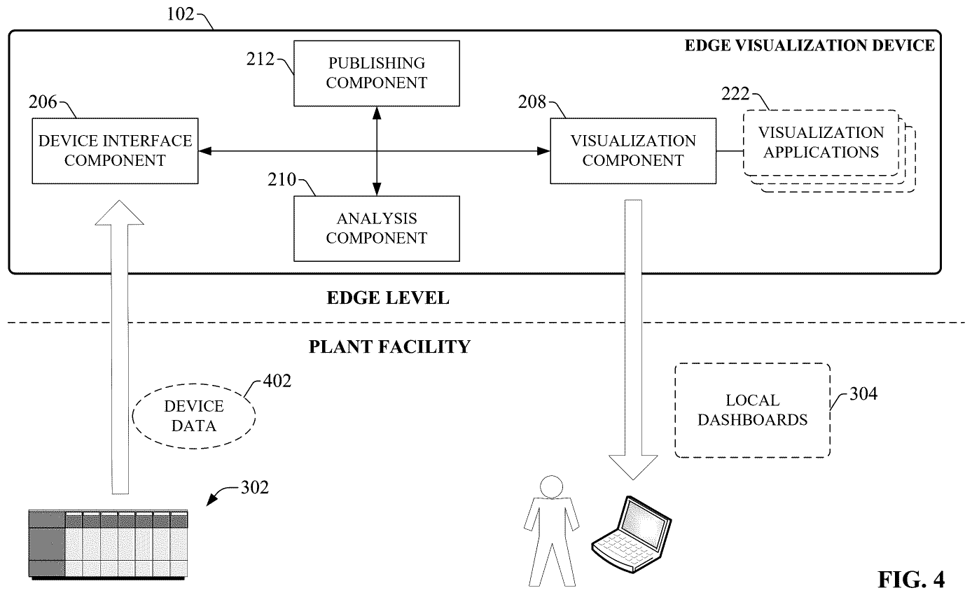

FIG. 4 is a diagram illustrating generation and delivery of local dashboards to a client device using the edge visualization device 102. Edge visualization device 102 is configured to host an industrial visualization runtime platform (e.g., visualization component 208) capable of executing visualization applications 222 or HMI applications. In some embodiments, the visualization runtime platform can execute on the device 102 as a containerized application, such that the platform runs on a container (e.g., a Docker container or another type of software container) that includes resources required to execute the visualization platform. Visualization applications 222 can define dashboards (e.g., graphical interfaces or HMI displays) on which real-time or historical data 402 collected from industrial assets 302 will be rendered. The visualization component 208 (e.g., the containerized visualization runtime platform) can expose and deliver local versions of these dashboard 304 to client devices having local access to the edge visualization device 102 over the plant network 108. The visualization component 208 can render selected subsets of device data 402 obtained from the industrial assets by the device interface component 206 on these local dashboards 304. In some embodiments, the device 102 can also include an analysis component 210 configured to perform analytics on selected subsets of the device data 402, and the visualization component 208 can render results of these analytics on the local dashboards 304. In some embodiments, the device 102 can render the local dashboard 304 and its associated data accessible via a web browser using hypertext transfer protocol (HTTP).

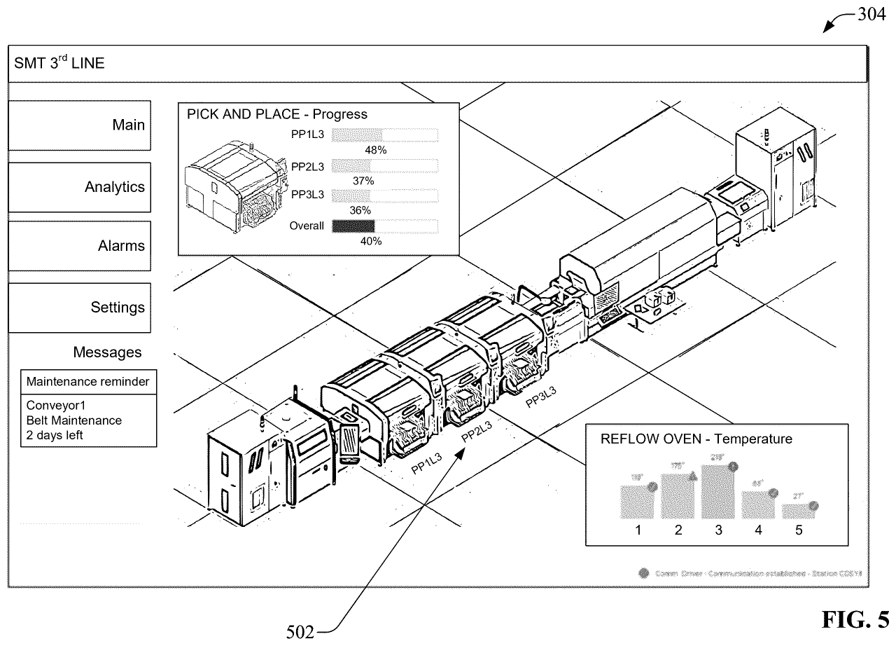

FIG. 5 is an example local dashboard 304 that can be generated and delivered by the visualization component 208. In this example, local dashboard 304 simulates a surface mount technology (SMT) line used for mounting components onto the surface of a printed circuit board. The dashboard renders a graphic 502 of the line together with status information for the line, alarm information, messages, results of analytics performed on operational data collected from the assets 302 that monitor and control the line, maintenance reminders, and other such information.

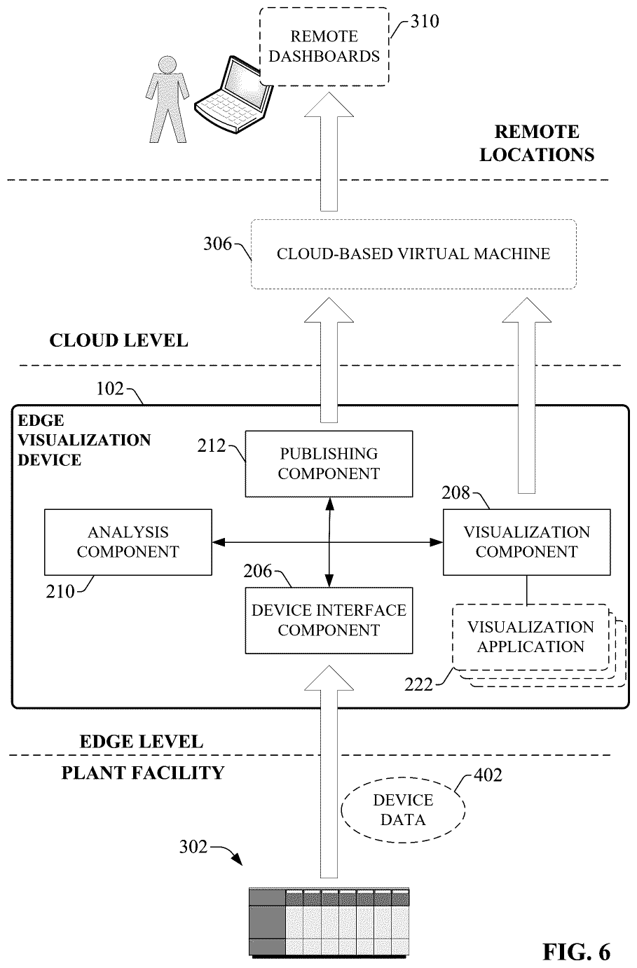

FIG. 6 is a diagram illustrating generation and delivery of remote dashboards to a client device using the edge visualization device 102. The edge visualization device 102 can include a publishing component 212 capable of reading data from the visualization runtime platform (the visualization component 208) and its associated visualization applications 222 (e.g., via an OPC-UA client), as well as device data 402 obtained by the device interface component 206. The publishing component 212 can send both selected sets of device data 402 as well as data from the visualization applications 222 to a virtual machine 306 executing on the cloud platform. Virtual machine 306 can include a message broker, such as a Message Queuing Telemetry Transport (MQTT) broker, that receives data from the publishing component 212, a database that stores data received from the publishing component 212, and a web-based visualization platform that generates or exposes remote dashboards 310 based on data received from the edge visualization device 102. Client devices at remote locations can then access and view these remote dashboards 310 via a web browser. Similar to local dashboards 304, remote dashboards 310 can render live or historical device data 402 obtained from the industrial assets by the edge visualization device 202 as well as results of analytics performed on the device data 402 by the analysis component 210. Data can be rendered on the local and remote dashboards as alphanumeric information, graphical animations, or other such formats. As in the case of the visualization component 208, the publishing component 212 can execute on the device 102 as a containerized application.

In an example embodiment, the publishing component 212 can be configured to read data from a visualization application 222 via OPC-UA client. This data can include, but is not limited to, dashboard definition information defined by the visualization application 222. The publishing component 212 can also read real-time device data 402 from the industrial assets 302 and any analytic results generated by the analysis component 210 to be included on the dashboard 310, and map this device and analytic data to corresponding data containers (e.g., alphanumeric or graphical objects) on the dashboard 310 defined by the visualization application 222. The publishing component 212 can then send this collected information to the cloud-based virtual machine 306 using MQTT or another suitable communication protocol. The virtual machine 306 receives this data via an MQTT broker, and uses this data to generate a web-based remote dashboard 310 accessible to remote users via a web browser.

In some embodiments, the visualization platform—represented by the visualization component 208—can send its information to the virtual machine 306 (e.g., using MQTT) separately from the publishing component 212. In an example of such an embodiment, the visualization component 208—a first containerized application that generates dashboards based on the defined visualization applications 222—can send definition information for the dashboards to the virtual machine using MQTT. Separately, the publishing component 212—a second containerized application executing on the device 202—can send a subset of the collected device data 402 to be rendered on the dashboards to the virtual machine, which integrates this device data 402 with the dashboard definition information sent by the visualization component 208 to yield the remote dashboard 310.

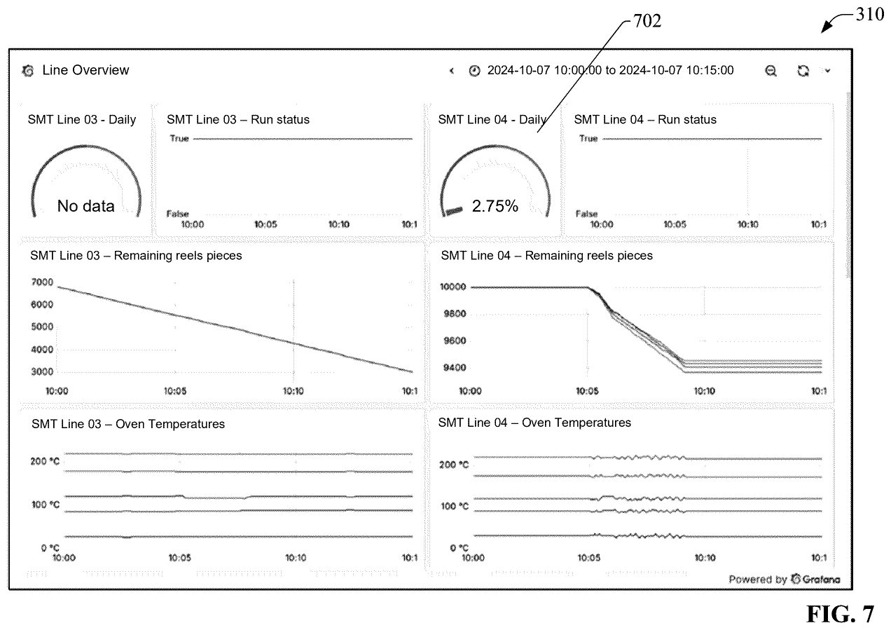

FIG. 7 is an example remote dashboard 310 that can be generated and delivered in this manner. This example remote dashboard 310 renders overview information for two SMT lines (SMT Line 03 and SMT Line 04) on the left and right sides, respectively, of the dashboard 310. This overview information includes a gauge 702 conveying a daily count percentage for each line, a line graph conveying a run status of each line over time, a line graph conveying remaining reels pieces for each line over time, and a line graph conveying an oven temperature for each line over time. In this example, all the data conveyed in the dashboard 310 is received from the visualization component 208 (as a visualization of the visualization applications 222) except for the gauge 702, which receives its data from the publishing component 212 (e.g., from a Docker container).

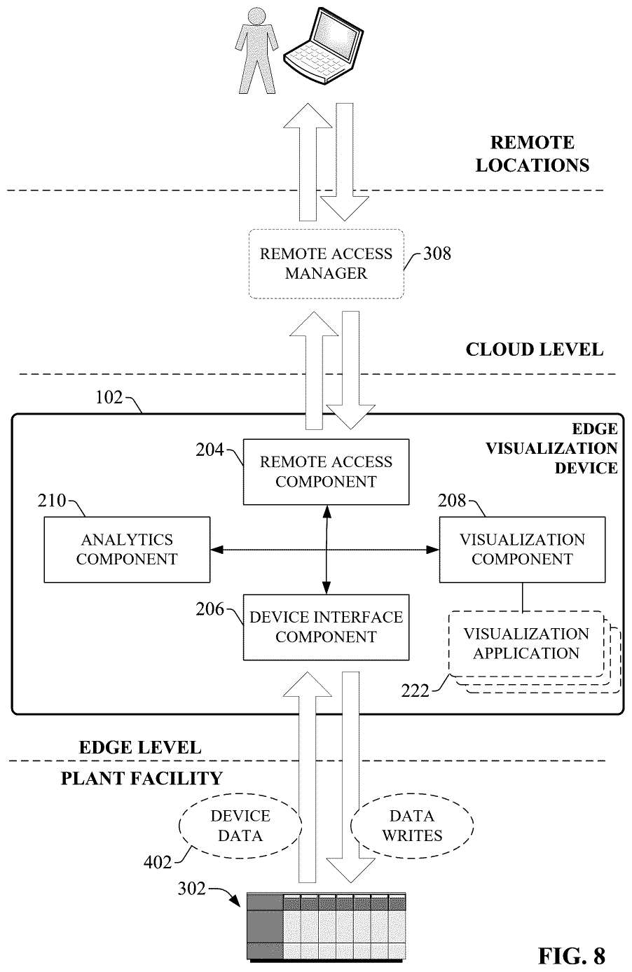

FIG. 8 is a diagram illustrating an architecture in which the edge visualization device 102 acts as an edge-level gateway for remote access to the industrial assets 302. The edge visualization device 102 can include a remote access component 204 configured to interface with a cloud-based remote access manager to allow remote access to selected industrial assets 302 for the purposes of remote maintenance and support. The remote access component 204 can generate and deliver, through the remote access manager 308, web-based interface displays that allow an authorized user at a remote location to select an asset 302 to be viewed, and that display operational, diagnostic, or configuration information obtained from the selected asset 302. This data can include, for example, values stored in data tags, diagnostic information stored on the asset 302, configuration parameter values, control programming, digital or analog I/O values, or other such information. The remote access component 204 can also allow the remote user to modify writable data values (such as configuration parameter values or control programming) to the asset 302 via interaction with the interface displays.

For example, the remote access component 204 can serve, to the remote access manager 308, a web-based interface display that renders a selected subset of device configuration parameter values, or control code, read from an industrial device as part of the device data 402. The remote access manager 308 renders these interfaces available to remote client devices having appropriate authorization to view and edit these configurable parameters. Users can modify selected parameters or control code via interaction with these web-based interfaces, and the remote access manager 308 can send these modified values or edited control code to the remote access component 204, which writes the edited values to their corresponding device data tags or program memory on the appropriate devices. As in the case of the publishing component 212 and the visualization component 208, the remote access component 204 can execute on the device 102 as a containerized application.

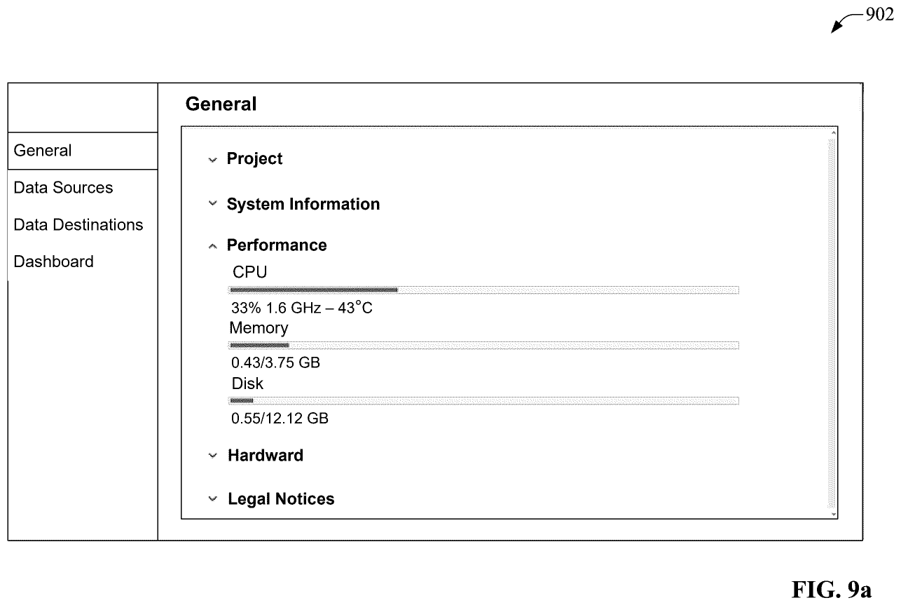

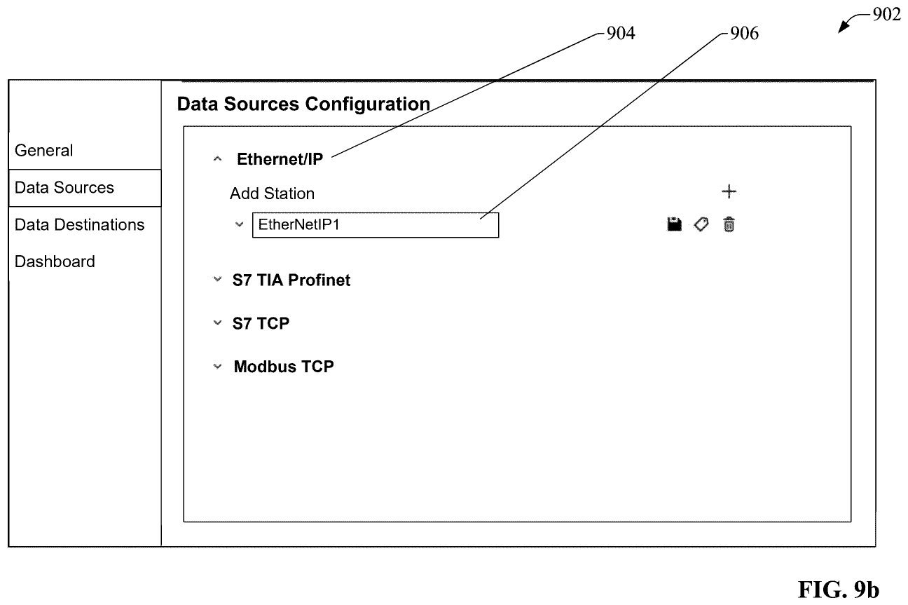

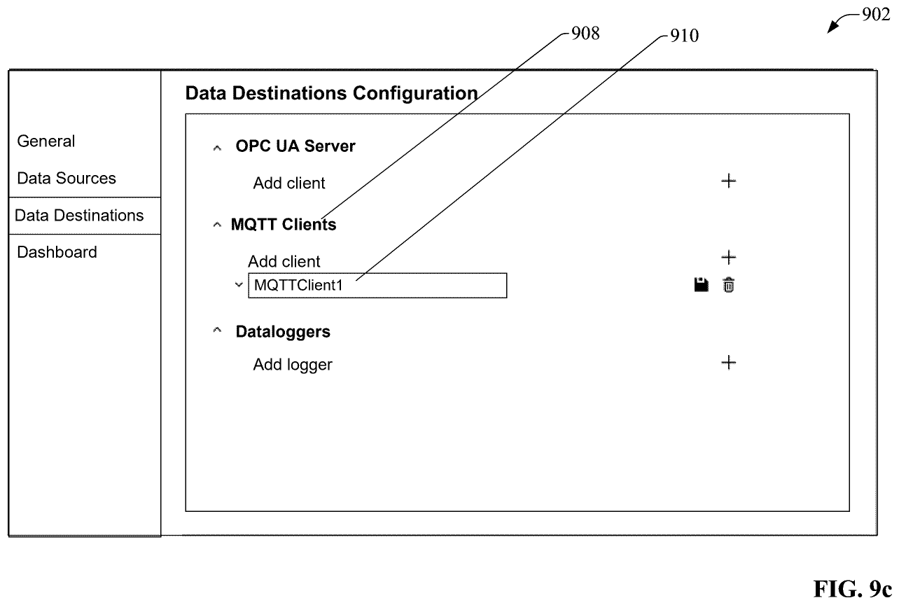

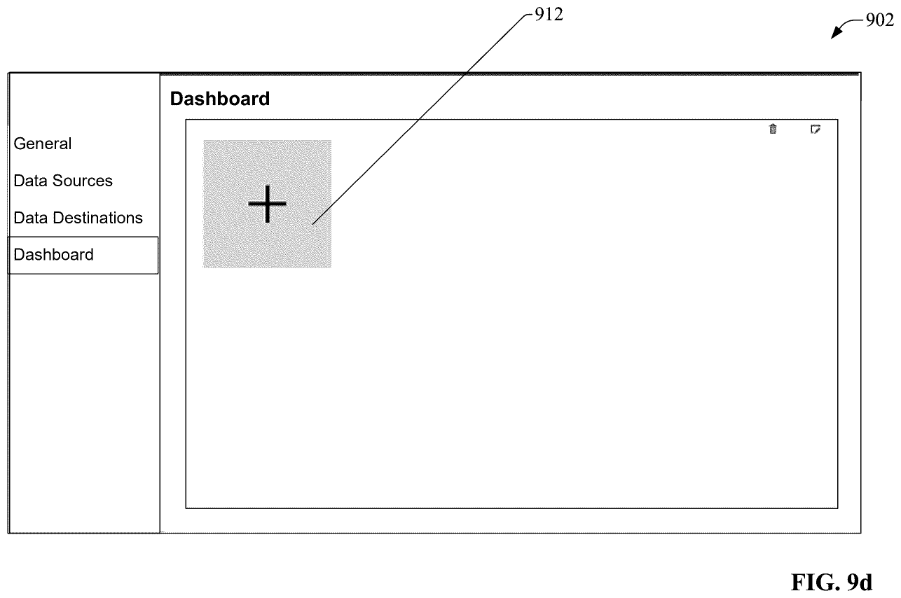

FIGS. 9a-9d are views of an example device configuration interface 902 that can be generated by the edge visualization device 102 and rendered on a client device. This device configuration interface 902 can be used to configure the device 102 for a particular data visualization solution and to view diagnostic data for the device 102. In some embodiments, the device 102 can render the device configuration interface in a web-based format so that the device 102 can be configured using a web browser. FIG. 9a is a General view of the device configuration interface 902, which displays information about the visualization project, system information for the device 102, performance information for the device 102 (e.g., processor and memory utilization), and hardware information. FIG. 9b is a Data Sources view of the device configuration interface 902, which allows the user to add and configure data sources or stations from which the device 102 will collect device data 402. The device 102 can support multiple data source protocols, including but not limited to Ethernet/IP, S7 TIA Profinet, S7 TCP, and Modbus TCP. The Data Sources view can list these supported data source protocols as selectable categories 904. To add a data source or station that supports a given communication protocol, the user can select the category 904 corresponding to the protocol to expand the selected category 904, and add the new data source or station in a configuration field 906 below the category 904.

FIG. 9c is a Data Destinations Configuration view of the device configuration interface 902, which allows the user to define data destination clients for the device 102. These can include, for example, OPC UA servers, MQTT clients, dataloggers, or other such clients. Similar to the Data Sources view, the Data Destinations view can list the various types of destination clients as selectable categories 908. Selection of a category 908 expands that category of destination devices and allows the user to configure a new destination device in a configuration field 910 below the selected category 908. FIG. 9d is a Dashboard view of the device configuration interface 902, which can be used to add dashboards or visualization applications 222 to the device 102. Selecting the Add icon 912 on this view can render configuration tools that allow the user to import a pre-configured dashboard to add as part of a visualization application 222 or to define a new dashboard for the application 222.

The edge visualization device 102 described herein can simplify the process of configuring an IIoT solution for making real-time plant floor data accessible from remote locations outside the plant. The headless standalone device 102 can be easily installed on the edge level of an industrial architecture (e.g., as a cabinet-mounted device), and provides intuitive configuration tools for configuring the device to collect, analyze, and serve data from local industrial assets to a cloud-based virtual machine as a remote dashboard that can be accessed from any location. The device 102 also serves as an edge-level gateway through which users can remotely access their industrial assets, allowing those users to view and modify configurable parameters of their industrial processes and devices from remote locations.

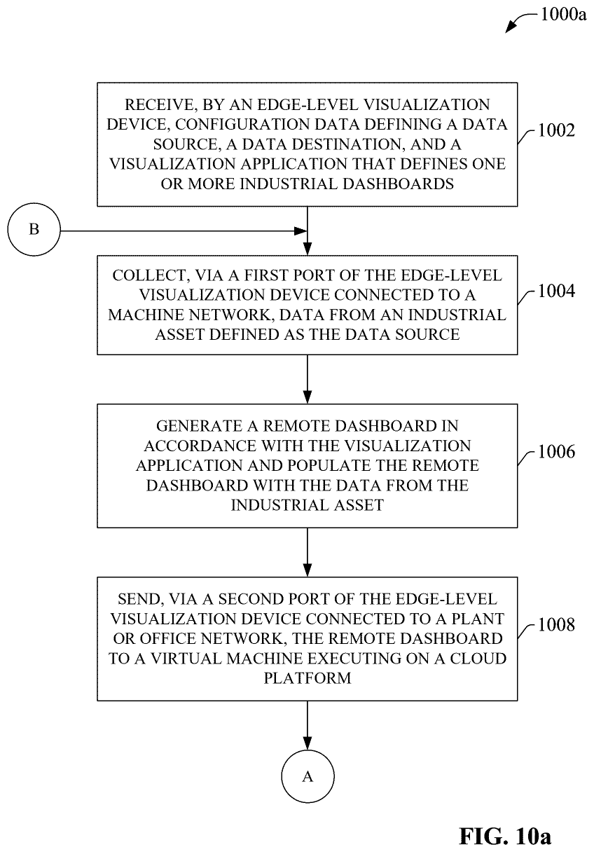

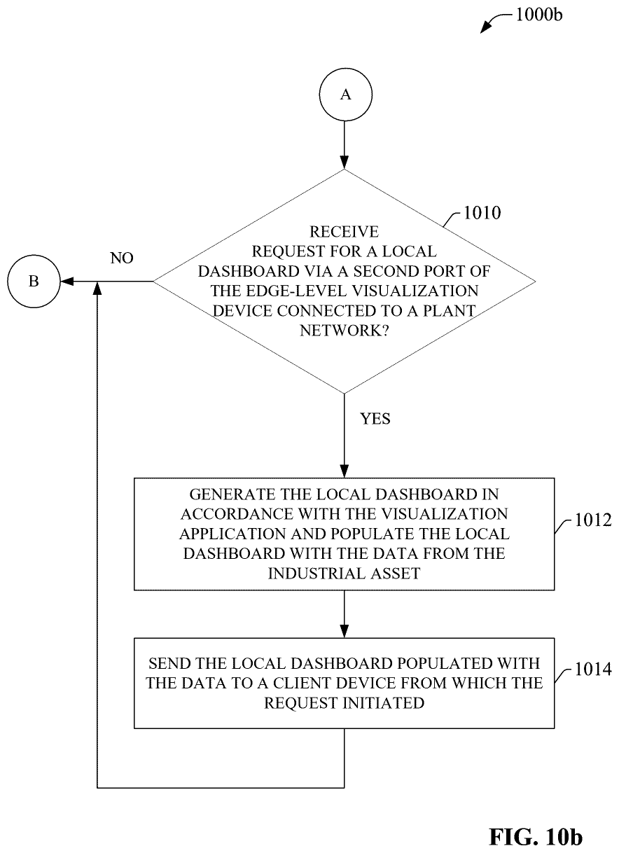

FIGS. 10a-10b illustrate a methodology in accordance with one or more embodiments of the subject application. While, for purposes of simplicity of explanation, the methodology shown herein is shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation. Furthermore, interaction diagram(s) may represent methodologies, or methods, in accordance with the subject disclosure when disparate entities enact disparate portions of the methodologies. Further yet, two or more of the disclosed example methods can be implemented in combination with each other, to accomplish one or more features or advantages described herein.

FIG. 10a illustrates a first part of an example methodology 1000a for serving local and remote industrial dashboards from an edge-level visualization device. Initially, at 1002, configuration data defining a data source, a data destination, and a visualization application is received by an edge-level visualization device. The edge-level device can comprise can be a headless stand-alone device with a first port for connecting to a machine network of an industrial facility on which industrial devices or assets reside, and a second port for connecting to a plant or office network through which a cloud platform can be accessed. These ports can support any suitable networking protocol, including but not limited to network address translation (NAT), 1:1 NAT, routing, internet sharing, or other such protocols. The visualization application stored on the edge-level device can define one or more industrial dashboards for rendering real-time data collected from the industrial assets in graphical or alphanumeric formats.

At 1004, data from an industrial asset defined as the data source by the configuration data received at step 1002 is collected by the edge-level device via the first port connected to the machine network. This data can include, for example, values stored in the asset's data tags, diagnostic information stored on the asset, configuration parameter values, control programming, digital or analog I/O values, or other such data. At 1006, a remote dashboard is generated by the edge-level device in accordance with the visualization application, and the remote dashboard is populated with the data collected from the industrial asset at step 1004. At 1008, the remote dashboard is sent, via the second port connected to the plant or office network, to a cloud-based virtual machine defined as the data destination by the configuration data received at step 1002. The virtual machine serves web-based versions of the remote dashboard—including live real-time values of the asset data served by the edge-level devices—to remote client devices authorized to access the virtual machine.

The methodology then proceeds to the second part 1000b illustrated in FIG. 10b. At 1010, a determination is made as to whether a request for a local dashboard is received via the second port of the edge-level device connected to the plant network. This request can be originated by a client device that is networked to the edge-level device via the local plant or office network. If such a request is received (YES at step 1010), the methodology proceeds to step 1012, where the edge-level device generates the requested local dashboard in accordance with the visualization application and populates the local dashboard with the data collected from the industrial asset at step 1004. At 1014, the edge-level device sends the local dashboard, populated with the data, to the client device from which the request initiated via the second port (that is, via the local plant network).

Embodiments, systems, and components described herein, as well as control systems and automation environments in which various aspects set forth in the subject specification can be carried out, can include computer or network components such as servers, clients, programmable logic controllers (PLCs), automation controllers, communications modules, mobile computers, on-board computers for mobile vehicles, wireless components, control components and so forth which are capable of interacting across a network. Computers and servers include one or more processors—electronic integrated circuits that perform logic operations employing electric signals—configured to execute instructions stored in media such as random access memory (RAM), read only memory (ROM), a hard drives, as well as removable memory devices, which can include memory sticks, memory cards, flash drives, external hard drives, and so on.

Similarly, the term PLC or automation controller as used herein can include functionality that can be shared across multiple components, systems, and/or networks. As an example, one or more PLCs or automation controllers can communicate and cooperate with various network devices across the network. This can include substantially any type of control, communications module, computer, Input/Output (I/O) device, sensor, actuator, and human machine interface (HMI) that communicate via the network, which includes control, automation, and/or public networks. The PLC or automation controller can also communicate to and control various other devices such as standard or safety-rated I/O modules including analog, digital, programmed/intelligent I/O modules, other programmable controllers, communications modules, sensors, actuators, output devices, and the like.

The network can include public networks such as the internet, intranets, and automation networks such as control and information protocol (CIP) networks including DeviceNet, ControlNet, safety networks, and Ethernet/IP. Other networks include Ethernet, DH/DH+, Remote I/O, Fieldbus, Modbus, Profibus, CAN, wireless networks, serial protocols, and so forth. In addition, the network devices can include various possibilities (hardware and/or software components). These include components such as switches with virtual local area network (VLAN) capability, LANs, WANs, proxies, gateways, routers, firewalls, virtual private network (VPN) devices, servers, clients, computers, configuration tools, monitoring tools, and/or other devices.

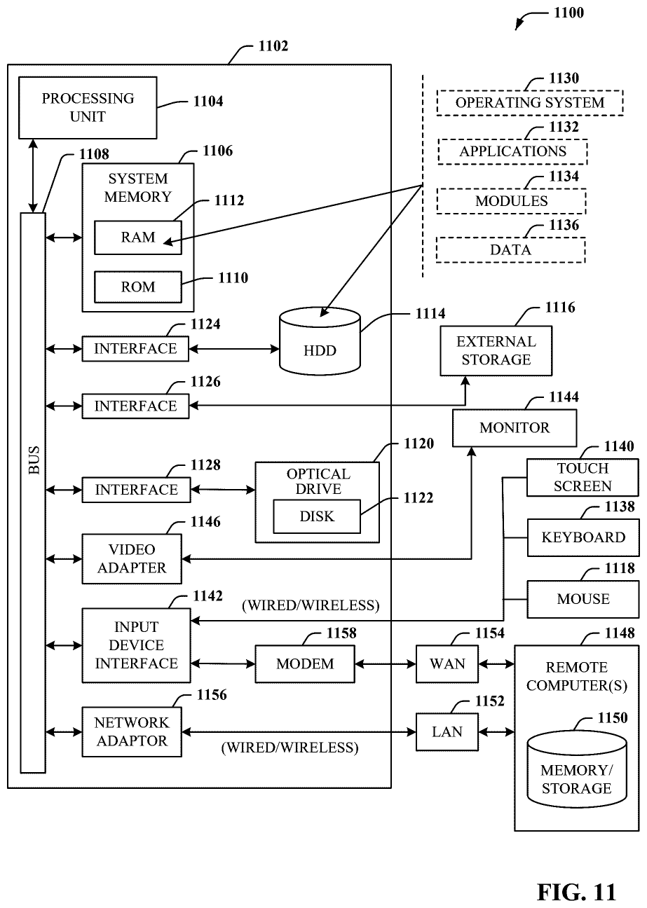

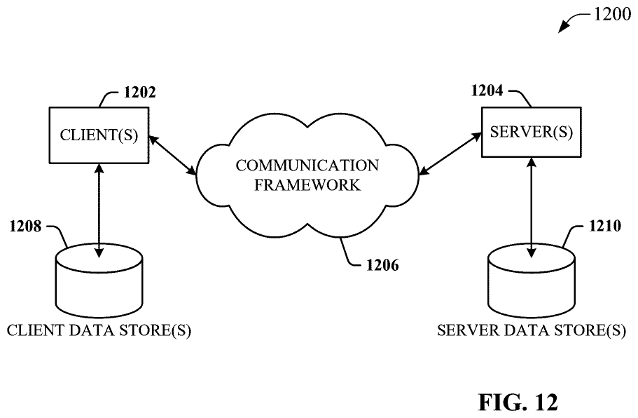

In order to provide a context for the various aspects of the disclosed subject matter, FIGS. 11 and 12 as well as the following discussion are intended to provide a brief, general description of a suitable environment in which the various aspects of the disclosed subject matter may be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1008. The system bus 1008 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for application programs 1132. Runtime environments are consistent execution environments that allow application programs 1132 to run on any operating system that includes the runtime environment. Similarly, operating system 1130 can support containers, and application programs 1132 can be in the form of containers, which are lightweight, standalone, executable packages of software that include, e.g., code, runtime, system tools, system libraries and settings for an application.

Further, computer 1102 can be enable with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1118. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1144 or other type of display device can be also connected to the system bus 1108 via an interface, such as a video adapter 1146. In addition to the monitor 1144, a computer typically includes other peripheral output devices (not shown), such as speakers, printers, etc.

The computer 1102 can operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1152 through a wired and/or wireless communication network interface or adapter 1156. The adapter 1156 can facilitate wired or wireless communication to the LAN 1152, which can also include a wireless access point (AP) disposed thereon for communicating with the adapter 1156 in a wireless mode.

When used in a WAN networking environment, the computer 1102 can include a modem 1158 or can be connected to a communications server on the WAN 1154 via other means for establishing communications over the WAN 1154, such as by way of the Internet. The modem 1158, which can be internal or external and a wired or wireless device, can be connected to the system bus 1108 via the input device interface 1142. In a networked environment, program modules depicted relative to the computer 1102 or portions thereof, can be stored in the remote memory/storage device 1150. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1152 or WAN 1154 e.g., by the adapter 1156 or modem 1158, respectively. Upon connecting the computer 1102 to an associated cloud storage system, the external storage interface 1126 can, with the aid of the adapter 1156 and/or modem 1158, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 12 is a schematic block diagram of a sample computing environment 1200 with which the disclosed subject matter can interact. The sample computing environment 1200 includes one or more client(s) 1202. The client(s) 1202 can be hardware and/or software (e.g., threads, processes, computing devices). The sample computing environment 1200 also includes one or more server(s) 1204. The server(s) 1204 can also be hardware and/or software (e.g., threads, processes, computing devices). The servers 1204 can house threads to perform transformations by employing one or more embodiments as described herein, for example. One possible communication between a client 1202 and servers 1204 can be in the form of a data packet adapted to be transmitted between two or more computer processes. The sample computing environment 1200 includes a communication framework 1206 that can be employed to facilitate communications between the client(s) 1202 and the server(s) 1204. The client(s) 1202 are operably connected to one or more client data store(s) 1208 that can be employed to store information local to the client(s) 1202. Similarly, the server(s) 1204 are operably connected to one or more server data store(s) 1210 that can be employed to store information local to the servers 1204.

What has been described above includes examples of the subject innovation. It is, of course, not possible to describe every conceivable combination of components or methodologies for purposes of describing the disclosed subject matter, but one of ordinary skill in the art may recognize that many further combinations and permutations of the subject innovation are possible. Accordingly, the disclosed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the disclosed subject matter. In this regard, it will also be recognized that the disclosed subject matter includes a system as well as a computer-readable medium having computer-executable instructions for performing the acts and/or events of the various methods of the disclosed subject matter.

In addition, while a particular feature of the disclosed subject matter may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

In this application, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips...), optical disks [e.g., compact disk (CD), digital versatile disk (DVD) . . . ], smart cards, and flash memory devices (e.g., card, stick, key drive . . . ).

What is claimed is:

1. A device, comprising:
a memory that stores executable components; and
a processor, operatively coupled to the memory, that executes the executable components, the executable components comprising:
a device interface component configured to read device data from industrial assets of an automation system via a machine network of an industrial enterprise;
a visualization component configured to generate a dashboard in accordance with a visualization application stored on the device; and
a publishing component configured to publish the dashboard and the device data to a cloud-based virtual machine as an animated dashboard accessible via a web browser.

2. The device of claim 1, wherein
the device interface component reads the device data via a first port configured to connect to a first network on which the industrial assets reside, and
the publishing component is configured to publish the dashboard and the device data via a second port configured to connect to a second network that interfaces with a cloud platform on which the cloud-based virtual machine executes.

3. The device of claim 2, wherein the visualization component is further configured to, in response to receipt, from a client device via the second network, of a request for a local version of the dashboard, render the local version of the dashboard and the device data on the client device via the second network as a local animated dashboard.

4. The device of claim 1, wherein at least one of the visualization component or the publishing component executes on the device as a containerized application.

5. The device of claim 1, the executable components further comprising an analytics component configured to perform analytics on the device data to yield an analytic result, wherein the visualization component is configured to render the analytic result on the animated dashboard.

6. The device of claim 1, wherein the cloud-based virtual machine comprises a message broker configured to receive the dashboard and the device data from the device, a database that stores the device data, and a visualization platform that generates the animated dashboard based on the dashboard and the device data received from the publishing component.

7. The device of claim 6, wherein
the visualization component is a first containerized application executing on the device that sends definition data for the dashboard to the virtual machine based on the visualization application, and
the publishing component is a second containerized application executing on the device that sends the device data to the virtual machine.

8. The device of claim 1, wherein the executable components further comprise a remote access component configured to
send, to a remote access manager that executes on a cloud platform, a web-based interface display that renders a subset of the device data comprising configurable parameters of one or more industrial devices of the industrial assets, and
in response to receipt, via interaction with the web-based interface display, of an edit to a value of a configurable parameter of the configurable parameters, write the edit to a data tag of an industrial device that stores the configurable parameter.

9. The device of claim 1, wherein the device data comprises at least one of data values stored in data tags of an industrial controller, diagnostic information stored on an industrial device, configuration parameter values, control programming, digital I/O values, or analog I/O values.

10. The device of claim 1, wherein
the visualization component is further configured to render, on a client device, configuration interfaces configured to receive configuration information that configures the device, and
the configuration information comprises at least one of a definition of the industrial assets that are to serve as sources of the device data, a definition of a destination for the device data, or a definition of the visualization application.

11. A method, comprising:
reading, by an edge-level visualization device, device data from industrial assets of an automation system via a machine network of an industrial enterprise;
generating, by the edge-level visualization device, a dashboard in accordance with a visualization application stored on the edge-level visualization device; and
publishing, by the edge-level visualization device, the dashboard and the device data to a cloud-based virtual machine as an animated dashboard accessible via a web browser.

12. The method of claim 11, wherein
the reading comprises reading the device data via a first port of the edge-level visualization device connected to a first network on which the industrial assets reside, and
the publishing comprises publishing the dashboard and the device data via a second port that connects to a second network that interfaces with a cloud platform on which the cloud-based virtual machine executes.

13. The method of claim 12, further comprising, in response to receiving, from a client device via the second network, a request for a local version of the dashboard, rendering, by the edge-level visualization device, the local version of the dashboard and the device data on the client device via the second network as a local animated dashboard.

14. The method of claim 11, wherein the generating and the publishing are executed by respective containerized applications on the edge-level visualization device.

15. The method of claim 11, further comprising
performing, by the edge-level visualization device, analytics on the device data to yield an analytic result, and
rendering, by the edge-level visualization device, the analytic result on the animated dashboard.

16. The method of claim 11, wherein the cloud-based virtual machine comprises a message broker configured to receive the dashboard and the device data from the device, a database that stores the device data, and a visualization platform that generates the animated dashboard based on the dashboard and the device data received from the edge-level visualization device.

17. The method of claim 11, further comprising:
Sending, by the edge-level visualization device to a remote access manager that executes on a cloud platform, a web-based interface display that renders a subset of the device data comprising configurable parameters of one or more industrial devices of the industrial assets, and
in response to receiving, via interaction with the web-based interface display, an edit to a value of a configurable parameter of the configurable parameters, writing, by the edge-level visualization device, the edit to a data tag of an industrial device that stores the configurable parameter.

18. The method of claim 11, wherein the device data comprises at least one of data values stored in data tags of an industrial controller, diagnostic information stored on an industrial device, configuration parameter values, control programming, digital I/O values, or analog I/O values.

19. A non-transitory computer-readable medium having stored thereon instructions that, in response to execution, cause an edge-level visualization device comprising a processor to perform operations, the operations comprising:
reading device data from industrial assets of an automation system via a machine network of an industrial enterprise;
generating a dashboard in accordance with a visualization application stored on the edge-level visualization device; and
publishing the dashboard and the device data to a cloud-based virtual machine as an animated dashboard accessible via a web browser.

20. The non-transitory computer-readable medium of claim 19, wherein
the reading comprises reading the device data via a first port of the edge-level visualization device connected to a first network on which the industrial assets reside, and
the publishing comprises publishing the dashboard and the device data via a second port that connects to a second network that interfaces with a cloud platform on which the cloud-based virtual machine executes.
